(19) United States
(12) Patent Application Publication
(10) Pub. No.: US 2010/0088753 A1
(43) Pub. Date: Apr. 8, 2010

(54) IDENTITY AND AUTHENTICATION SYSTEM USING ALIASES

(75) Inventors: Lynn C. Ayres, Bellevue, WA (US); Rui Chen, Kirkland, WA (US); Wei-Qiang Michael Guo, Bellevue, WA (US); Neelamadhaba Mahapatro, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,580

(22) Filed: Oct. 3, 2008

(51) Int. Cl. H04L 9/32; G06F 7/04; G06F 15/16

(52) U.S. Cl. 726/9; 709/206

(57) ABSTRACT

An identity and authentication platform utilizes a data model that enables multiple identities such as e-mail addresses, mobile phone numbers, nicknames, gaming IDs, and other user IDs to be utilized as aliases which are unique sub-identities of a main account name. A user may utilize the aliases supported by the platform to project multiple different on-line identities while using the authentication credentials of the main account. The platform is configured to expose the aliases to various client applications and Internet-accessible sites and services such as e-mail, instant messaging, media sharing, gaming and social networks, and the like, to enable the implementation of a variety of usage scenarios that employ aliases.

### BACKGROUND

For users and businesses alike, the Internet continues to be increasingly valuable. More people are using the Internet for everyday tasks, from shopping, banking, and paying bills to consuming media and entertainment. E-commerce is growing, with businesses delivering more services and content across the Internet, communicating and collaborating on-line, and inventing new ways for users to connect with each other. Users can presently access on-line resources from a diverse set of platforms including computers, mobile and smart phones, game consoles, and other devices that have network connectivity.

When accessing some sites and services, users need to be authenticated so that the interaction is appropriate and not misused in some way. For example, a user attempting to access a bank account on-line needs to be authenticated to verify that the user is who he claims to be (i.e., a legitimate bank customer who owns or is otherwise entitled to access the account). Another example is that users of social networking sites need to be authenticated, among other reasons, to prevent impersonators from gaining access to a user's page and posting malicious or false content. Authentication generally involves a user entering a user ID (or login ID, account name, user name, etc.) and a password or personal identification number (“PIN”) which are referred to as “credentials” to verify his or her identity.

While some authentication systems provide satisfactory performance, current systems do not meet all of the needs of the on-line community. For example, users want both flexibility in the identities they project on-line and a straightforward way to maintain the security of their identities without requiring the use of an ever-lengthening list of passwords (which can encourage insecure practices such as reusing account names and passwords across multiple web sites).

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An identity and authentication platform utilizes a data model that enables multiple identities such as e-mail addresses, mobile phone numbers, nicknames, gaming IDs′, and other user IDs to be utilized as aliases which are unique sub-identities of a main account name. A user may employ a generic set of authentication credentials or the credentials of the main account to access the aliases supported by the platform and project multiple different on-line identities using the aliases. The platform is further configured to expose the aliases to various client applications and Internet-accessible sites and services such as e-mail, instant messaging, media sharing, gaming and social networks, and the like, to enable the implementation of a variety of usage scenarios that employ aliases.

In various illustrative examples, web sites and services that support the use of aliases rely upon an identity and authentication service to provide authentication for users of the sites and services (collectively referred to as “relying services”). The relying services can operate in combination with applications that run on a web browser (i.e., “thin client” applications) or more feature-rich client applications (i.e., “thick client” applications) to provide a wide range of usage scenarios that employ aliases. For example, users can sign in to a relying service and be authenticated using their main account name and password or by using an alias and the same main account password.

Multiple e-mail accounts can be collectively managed (where each e-mail account identifies a user with a different alias) so that the user can sign in to a main e-mail account, be authenticated, and then receive e-mail messages that are addressed to the different e-mail aliases. And, a user of a relying service can find other users by using the aliases of such users. An invitation generated using an event planning service can be addressed, for example, to a user's alias but still get delivered to the user's main account. Or, a game player can look up and find another player's profile by alias on an on-line game service.

Users are provided with tools to manage their on-line identities using aliases. Users have the ability to create, update, and delete aliases and manage how they are used with the various services. Users may also set one or more attributes that are associated with their aliases to limit the extent to which the association between an alias and main account name is made public on a service. This enables the user to maintain privacy, whenever desired, while still receiving the benefits that aliases provide.

Advantageously, the present identity and authentication platform is extensible and scalable across a variety of services that can be operated by unrelated service providers (for example, e-mail aliases can be applied to e-mail accounts using different domains that are hosted by different providers). The platform provides a convenient and secure way for users to employ and expose aliases to manage how they are perceived in the on-line community while controlling when and how they can be reached and preserving their privacy when desired.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative on-line services environment in which users at client devices may interact with on-line sites and services that rely upon an identity and authentication service that supports aliases;

FIG. 2 shows an illustrative set of sites and services that may be used with aliases;

FIG. 3 shows illustrative thin client applications and thick client applications that may run on a client device;

FIG. 4 shows an illustrative aliases data model;

FIG. 5 shows an illustrative set of aliases that may be associated with a main account name;

FIG. 6 shows an illustrative set of attributes that may be associated with an alias;

FIG. 7 shows an illustrative set of methods that are exposed by an API (application programming interface) to the client applications and relying services;

FIG. 8 shows a first illustrative usage scenario in which a user may sign in to a service with an alias using a thin client application;

FIG. 9 shows a second illustrative usage scenario in which a user may sign in to a service with an alias using a thick client application;

FIG. 10 shows a third illustrative usage scenario in which a user may receive e-mail messages sent to multiple different e-mail aliases; and

FIG. 11 shows a fourth illustrative usage scenario in which a user may be reached by others through an alias.

Like reference numerals indicate like elements in the drawings. Elements are not drawn to scale unless otherwise indicated.

### DETAILED DESCRIPTION

Computer users frequently maintain different identities for use with different on-line sites and services. A single user may employ various identifiers such as e-mail addresses, nicknames, user names, mobile phone numbers, gaming names or IDs, and other constructs, at different times and in different settings to reflect the user's on-line identity. So, for example, a user may utilize a mobile phone number with a presence based network service, such as instant messaging (“IM”), which can operate with a mobile phone. In addition, the user might sign in with a user name to an on-line social networking site and use an e-mail address when logging on to a frequent-flyer account.

Users may find the maintenance of multiple identities burdensome. For example, as more sites and services require the creation of an account to use them, the proliferation of different account names and passwords can lead to “password fatigue” for users. For these users it can be difficult to remember their passwords which can lead to users reusing the same credentials across multiple sites and services. Not only can such practice pose a vulnerability to theft and identity fraud, but the user loses flexibility in how they present themselves to the on-line community.

Users often want the ability to represent themselves with different identities because it allows them to tailor their identity to a particular on-line context and, in some cases, broaden the ability for others to reach them. However, users are typically only allowed to have a single identity associated with a given account across most on-line services. While there are existing services where multiple nicknames can be associated with one account, these are presently limited to on-line services involving group discussions and the nicknames cannot be used outside the group. Nor can the nickname be utilized to sign in to the main account. These limitations can frustrate users who want to have rich social interactions on-line.

The present identity and authentication system benefits users and addresses limitations of the current on-line environment. The system provides users with an easy way to manage their on-line identities using aliases to control how they can be reached and when.

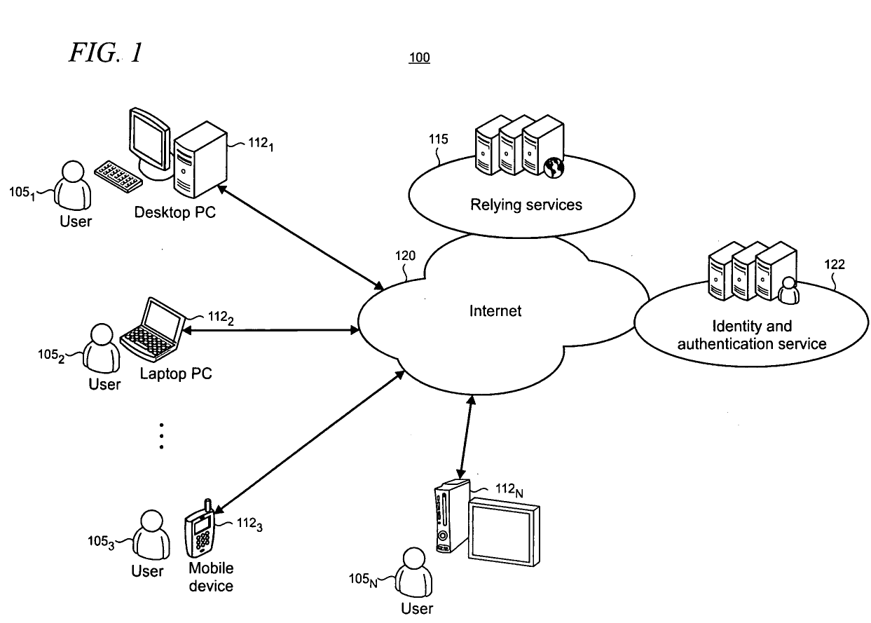

Turning now to the drawings, FIG. 1 shows an illustrative on-line services environment 100 in which users 105_{1, 2 . . . N} at respective client devices 112_{1, 2 . . . N} may interact over a network such as the Internet 120 with various on-line sites and services. The client devices 112 may take a variety of form factors and be configured with different capabilities and resources. In this example, the client devices 112 include a desktop PC 112₁, a laptop PC 112₂, a mobile device 112₃ (e.g., smart phone, mobile phone, etc.), and a video game console 112_{N}. However, it is emphasized that these devices are intended to be illustrative and that other types of devices may also be utilized as may be required to meet the needs of a particular implementation.

On-line sites and services are configured to rely upon a service 122 to provide identity and authentication. Hence, the on-line sites and services are referred to as “relying services” and are collectively identified by reference numeral 115 in FIG. 1. The client devices 112, relying services 115, and the identity and authentication service typically communicate using HTTP (HyperText Transfer Protocol).

In some implementations, one or more of the relying services 115 and the identity and authentication service 122 may be operated by the same entity. However, this is not a requirement as a relying service provider may also delegate user authentication to an unaffiliated third party provider that operates the identity and authentication service 122.

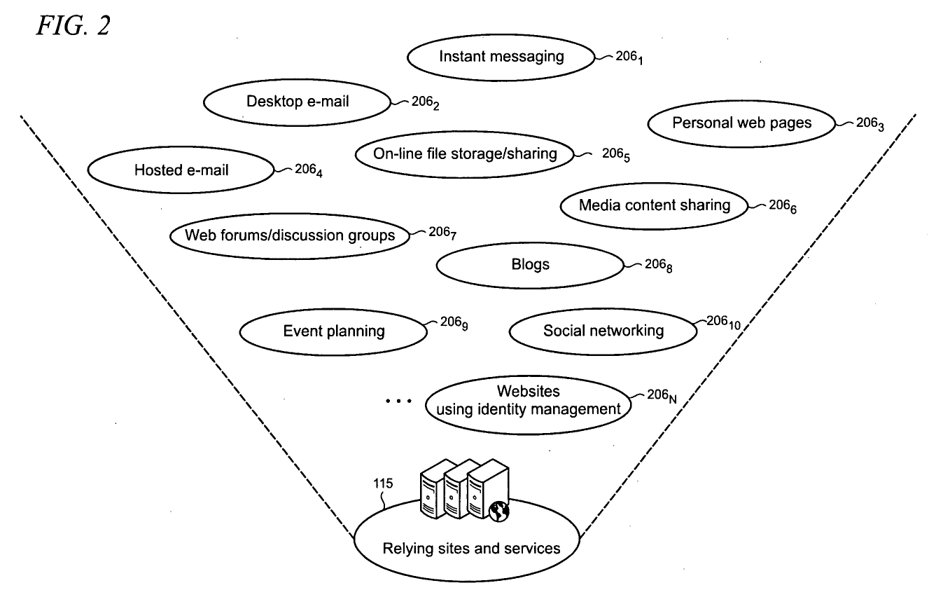

The relying services 115 may comprise a wide variety of different services that may be operated by one or more service providers. FIG. 2 shows illustrative examples of specific relying services that may be used in some implementations. The examples are intended to be illustrative as not all the examples shown in FIG. 2 need to be utilized in every application, and there could be other services used in a given implementation that are not shown. The illustrative relying services 115 include services which support: instant messaging 206₁; desktop e-mail 206₂; personal web pages 206₃; hosted e-mail 206₄; on-line file storage and/or sharing 206₅; media content (e.g., pictures, audio, or video) sharing 206₆; web forums and/or discussion groups 206₇; blogs (i.e., weblogs) 206₈; event planning 206₉; or social networking 206₁₀. Websites which provide services other than those listed above and which rely on the identity and authentication service 122 may also be utilized (as collectively identified by reference numeral 206_{N} in FIG. 2).

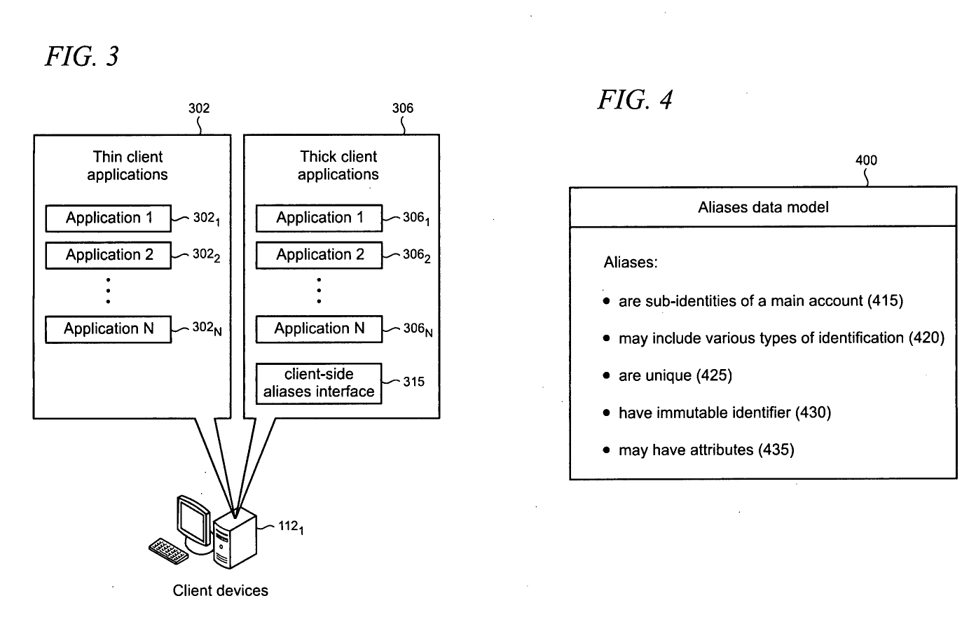

The client devices 112 (FIG. 1) will interact with the relying services 115 (and the identity and authentication service 122) through client applications that are installed and run on the devices in order to render a particular experience to a user 105 that employs aliases. As shown in FIG. 3, the client devices (as represented by desktop PC 112₁) can run a variety of client applications including both thin client applications 302_{1, 2 . . . N} and thick client applications 306_{1, 2 . . . N}. While N thick client and thin client applications are shown in FIG. 3, the particular type and number of applications utilized on a given client device 112 can vary by implementation and client device capabilities. For example, a mobile device might not run as many client applications as compared with PCs and game consoles, and those it does run will be tailored to the more resource-constrained runtime environment that is supported by the mobile device.

The thin client applications 302 are typically those that can be implemented using a web browser such as Microsoft Internet Explorer® on PCs and Internet Explorer Mobile for mobile devices. Thin client applications are commonly coded in browser-supported languages such as HTML (HyperText Markup Language) and XML (eXtensible Markup Language) and implement features such as scripting and ActiveX controls.

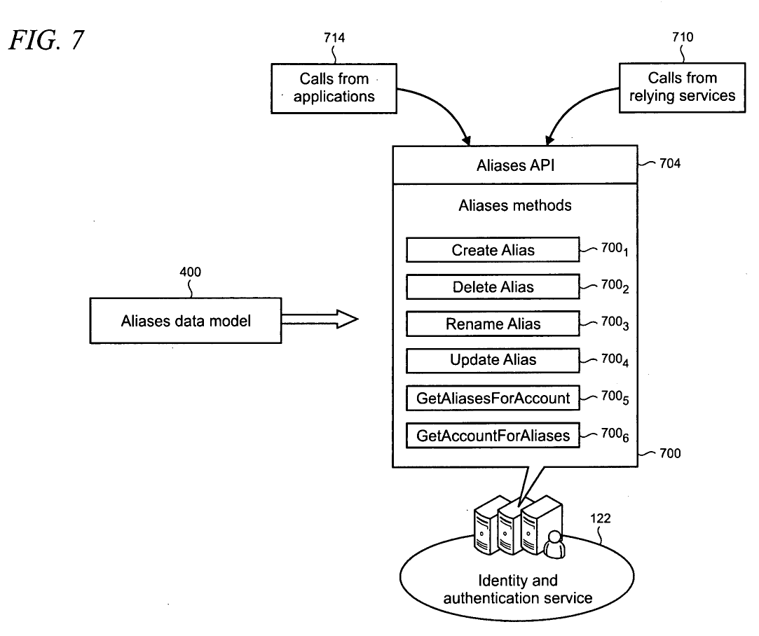

Thick client applications 306 are typically implemented as standalone applications using programming environments such as Win32 on the PC. Thick client applications commonly include applications such as desktop e-mail, blogging, and IM clients that typically provide a richer feature set and more flexibility for local data storage as compared to similar applications that are implemented as thin clients. In some implementations, alias functionality may be exposed to thick client applications 306 using a client-side aliases interface 315 (i.e., a locally installed API). However, such interface 315 is not necessarily used in all implementations, and some thick client applications 306 can be configured to interface directly with alias services, for example by invoking methods exposed through an API (application programming interface) that is supported by the identity and authentication service 122, as described in more detail below in the text accompanying FIG. 7.

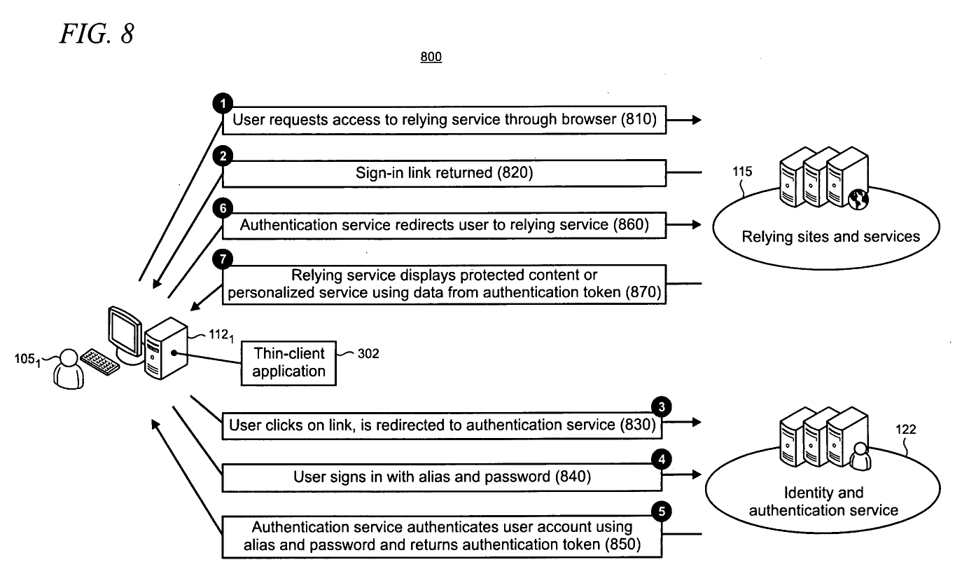

The identity and authentication service 122 (FIG. 1) is arranged to expose aliases to the relying services 115 and client applications 302 and 306 under a flexible data model that may support a wide range of alias usage scenarios (several of which are shown in FIGS. 8-11 and described in the accompanying text). FIG. 4 shows an illustrative aliases data model 400 which provides that aliases are sub-identities of a main account (as indicated by reference numeral 415). The main account may be provided by the identity and authentication service 122. For example, the identity and authentication service 122 may be implemented as part of Microsoft Windows Live ID™ service so that the main account comprises a Windows Live ID, such as an e-mail address (e.g., “user@live.com”, “user@hotmail.com”, etc.), that a user employs to access a variety of on-line services including those that Microsoft Corporation provides as well as those of third parties. In alternative arrangements, the main account may be supported by a provider of one of the relying services 115. Whoever the main account provider, generally speaking, the relying services 115 will agree (for example, through appropriately-scoped service contracts) that a given user 105 will be able to access all the relying services 115 and be authenticated by the identity and authentication service 122 using the main account and its associated aliases.

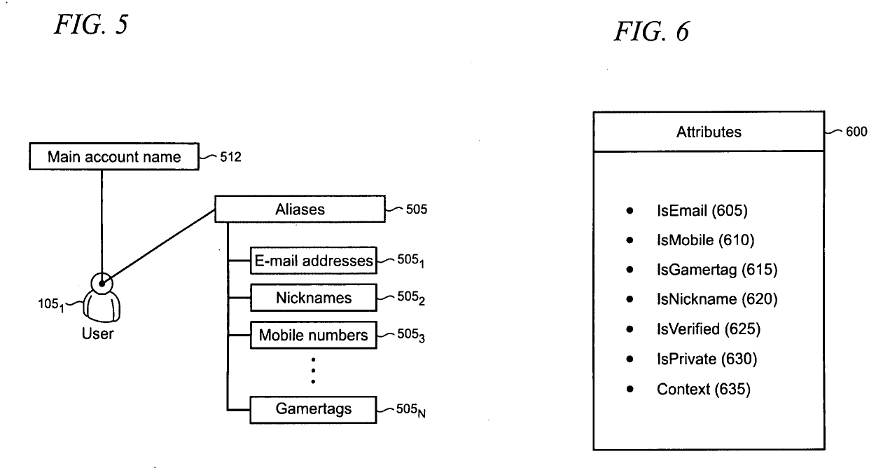

The aliases data model 400 further provides that aliases may include various types of identification (420). As shown in FIG. 5, a user (representatively indicated as user 105₁) may have available for use one or more aliases 505 that are associated with a main account name 512 (i.e., user@hotmail.com). The aliases illustratively include, but are not necessarily limited to e-mail addresses 505₁, nicknames 505₂, mobile phone numbers 505₃, and game player profile names referred to as “Gamertags” 505_{N} in the case of Microsoft Corporation's Xbox LIVE® on-line game service. These particular types of identification are illustrative and other types may be used as required by a particular application.

E-mail address aliases 505₁, may include e-mail addresses from different domains and may be supported by different and/or unrelated relying service providers. Nickname aliases 505₂ and gamertag aliases 505_{N} are names within a domain, although the domain itself will not be exposed to a user 105. For example, although a nickname alias includes the domain for (e.g., “nickname@domain.com”) for the purposes of the system tracking the origin of the alias, the alias used and seen by the user 105 is simply “nickname.”

Referring back to FIG. 4, the data model 400 provides that all aliases 505 are unique (425) within the services environment 100 and that each is associated with an immutable identifier (430) referred to here as an “AUID” (Alias Unique Identifier). Uniqueness under the model ensures that the users 105 can claim exclusive rights to use an alias and be unambiguously associated with the alias. And by being immutable (i.e., never changed or reassigned), the AUID enables system data to be associated with an alias and tracked so that continuity of service can be maintained in the event that a user 105 decides to update or modify an alias in any way. For example, as described in more detail below, a user 105 may wish to restrict the exposure of the main account name based on an inquiry using an alias. This restriction can be associated with the AUID so that if the name of the alias is changed (e.g., from “Nickname1” to “Nickname2”), the user's preference regarding privacy is maintained for the new alias name.

The data model 400 further provides that aliases may have attributes (435) which form the core for defining an identity for a user 105. An illustrative set of attributes 600 is shown in FIG. 6. The attributes in this example include:
IsEmail (as indicated by reference numeral 605)
IsMobile (610)
IsGamertag (615)
IsNickname (620)
IsVerified (625)
IsPrivate (630)
Context (635)
   It is noted that not all the attributes shown above need to be used with any given implementation.

The attributes IsEmail 605, IsMobile 610, IsGamertag 615, and IsNickname 620 are used respectively to identify the alias type. Such identification may be utilized to enable the relying service 115 and identity and authentication service 122 to use the aliases in a manner that is appropriate to their type. A message designed for delivery to an e-mail alias would not necessarily work effectively when sent to a mobile phone number alias, for example, due to variations in message protocols and differences in device characteristics such as display and rendering capabilities.

The IsVerified attribute 625 is typically applicable when an e-mail address is used as an alias and the e-mail address is provided by a relying service 115 that is unrelated to the provider of the identity and authentication service 122. In such cases, the service 122 needs to verify the validity of the alias before allowing it to be associated with the main account and used by the relying services 115. An IsVerified attribute flag will be set for an e-mail alias when its user has verified that he or she owns that e-mail address. Otherwise, the e-mail alias is tracked by the service 122 as being unverified which will typically limit the usage scenarios in which the unverified alias can be utilized.

For example, if an invitation is sent using an unverified alias (i.e., the IsVerified attribute flag for that alias is not set) to an invitee from a user of the event planning service 206₉, then the invitee will be unable to accept the invitation until the invitee can show that the alias belongs to the invitee and has rights to it. The unverified e-mail alias may get verified through a method in which the identity and authentication service 122 sends a separate e-mail that is addressed to the unverified e-mail alias. The e-mail from the service 122 includes a verification link containing a verification token. When the link is clicked it will open a web page where the invitee can sign in to thereby prove that the verification e-mail was received at a legitimate inbox for the e-mail alias.

Verification can also work for mobile phone numbers that are used as aliases. An SMS (Short Message Service) message containing a code may be sent to the mobile phone number alias. The user can go to a website that is set up using, for example, a PC or the mobile browser on the phone and enter the code from the SMS message into a user interface provided by the site to thereby verify the mobile number alias with the identity and authentication service 122.

The IsPrivate attribute 630 provides an indication as to the preference of the alias user in exposing the relationship between an alias 505 and the main account name 512. If the IsPrivate attribute flag is set, then the identity and authentication service 122 will not expose the main account name 512 underlying any alias 505 to a query from a caller. Thus, use of the IsPrivate attribute 630 enables a user to allow or prevent someone or some service from looking up the main account name that is associated with an alias. In some implementations, the reverse situation may also be supported where a user can allow or prevent a lookup of all aliases or a selected subset of aliases that are associated with a main account name.

The Context attribute 635 may be used to indicate the context in which aliases are utilized. For example, the Context attribute 635 can indicate which particular relying services 115 are being used or are otherwise associated with a given alias 505. Other relying services 115 may then use such context when implementing certain usage scenarios or service features. For example, the Context attribute 635 of an e-mail alias that is created inside a first relying service can be tagged, i.e., Context=service1. A second relying service can then check the Context attribute and see that the e-mail alias has not been used with the second service. It can then notify a user about the option to utilize the e-mail alias with the second relying service. Other uses of the Context attribute 635 may include displaying to a user 105 which aliases are being used with which relying services 115 or sorting aliases based on usage.

As shown in FIG. 7, the aliases data model 400 may be used to define various methods 700 that may be exposed by the identity and authentication service 122 through an API 704 to remote calls from the relying services 115 and applications 302 and 306 (respectively indicated by reference numerals 710 and 714). The methods 700 illustratively include:
Create Alias (indicated by reference numeral 700₁)
Delete Alias (700₂)
Rename Alias (700₃)
Update Alias (700₄)
GetAliasesForAccount (700₅)
GetAccountForAliases (700₆)

The Create Alias method 700₁ when invoked will create an alias that is associated with the main account name and set an initial set of attributes 600. If a verification token is supplied at the time the alias is created, then the attribute IsVerified 625 will be set so that the created alias 505 is a verified alias. The Delete Alias method 700₂ and Rename Alias method 700₃ enable an alias to be deleted from the system and renamed, respectively. If a user 105 renames an alias 505, as noted above, its attributes and any other data associated with it will be persisted using the immutable identifier (e.g., AUID). A caller may invoke the Update Alias method 700₄ to change the attributes 600 that are associated with an alias. For example, the IsPrivate attribute 630 can be toggled to enable or disable privacy.

Turning now to FIGS. 8-11, several illustrative usage scenarios that employ aliases are shown. It is emphasized that these usage scenarios are intended to highlight the kinds of service features and user experiences that the present system enables but should not be viewed to limit the scope of its applicability in any way.

FIG. 8 shows a first illustrative usage scenario 800 in which a user (representatively shown as user 105₁) may sign in to a relying service 115 with an alias using a thin client application 302 running on a desktop client device 112₁. While a desktop client device 112₁ is used in this example, the usage scenario would be similar for the other client devices shown in FIG. 1 and described in the accompanying text. The scenario begins when the user 105₁ attempts to access the relying service 115 using a web browser with which the thin client application 302 is implemented (as indicated by reference numeral 810).

The relying service 115 will return a page containing a sign-in link (820). When the user 105₁ clicks on the link, the user is redirected to the identity and authentication service 122 (830) to perform authentication of the user on behalf of the relying service 115. The identity and authentication service 122 presents a sign-in dialog box with which the user may sign in. While the user 105₁ has the option to sign in using the user's main account name and password, in this scenario the user signs in with an alias and password (840). Typically, the password will be the same password that is associated with the main account name for all the user's aliases for the convenience of the user 105₁. However, there is no requirement that the user employ a commonly-utilized password.

The identity and authentication service 122 authenticates the user 105₁ using the alias and password supplied and returns an authentication token back to the client (850). The authentication token will contain data, in encrypted form, including the main account name, password, and the AUID associated with the alias. The identity and authentication service 122 then redirects the user 105₁ to the relying service 115 (860). Using a secret key that is shared between the identity and authentication service 122 and the relying service 115 beforehand, the relying service 115 can pull and decrypt the data from the authentication token passed from the client to thereby display protected content or provide a personalized service to the user 105₁ (870). Since the authentication token includes the authentication credentials of the main account, signing in to the relying service 115 with an alias works to authenticate the user 105₁ by authenticating the underlying main account. This feature guarantees the user 105₁ access to appropriate content and personalization since the relying service 115 will always recognize the main account name.

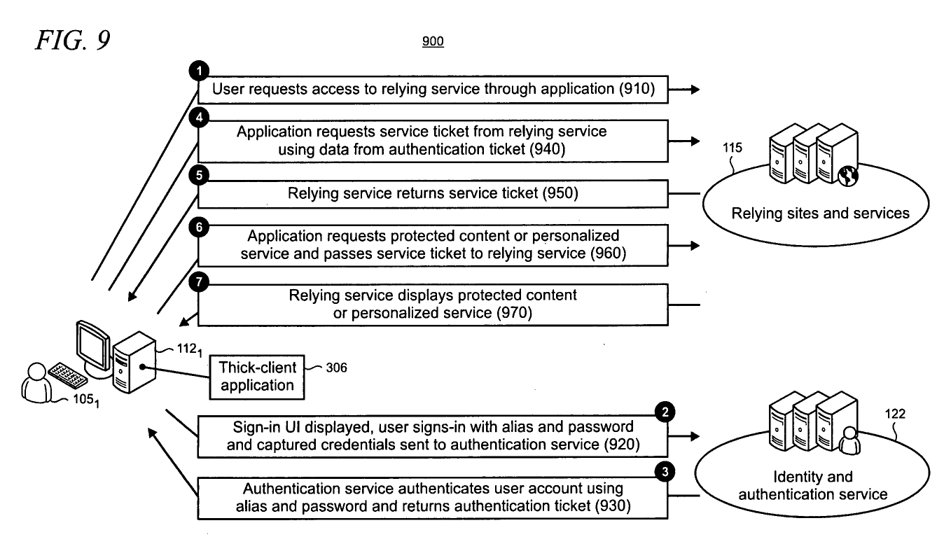

FIG. 9 shows a second illustrative usage scenario 900 in which the user 105₁ may sign in to a relying service 115 with an alias using a thick client application 306 running on a desktop client device 112₁. This usage scenario is similar to scenario 800 that employs a thin client application but varies in implementation detail. The scenario begins when the user 105₁ attempts to access the relying service 115 through the application 306 (as indicated by reference numeral 910). A sign-in UI (user interface) is presented to the user 105₁. The user signs in to the UI with an alias and password and the captured credentials are sent to the identity and authentication service 122 (920). In some implementations, the client-side aliases interface 315, shown in FIG. 3 and described in the accompanying text, can be configured to expose an API to the thick client application to enable the capture and sending functions.

The identity and authentication service 122 authenticates the user 105₁ using the alias and returns an authentication ticket back to the client (930) that contains data, in encrypted form, including the main account name, password, and the AUID associated with the alias. The thick client application 306 can use the data to request one or more service tickets from the relying service 115 (940). In a similar manner as with the scenario 800 above, the fact that the authentication ticket includes the main account name enables the relying service to appropriately identify the user 105₁ even though the user signs in with an alias. The relying service can then return the appropriate service tickets (950).

The thick client application 306 next requests protected and/or personalized content and services from the relying service by passing a service ticket received in the previous step to the relying service (960). The relying service 115 provides the content or service to the user 105₁ responsively to the request (970).

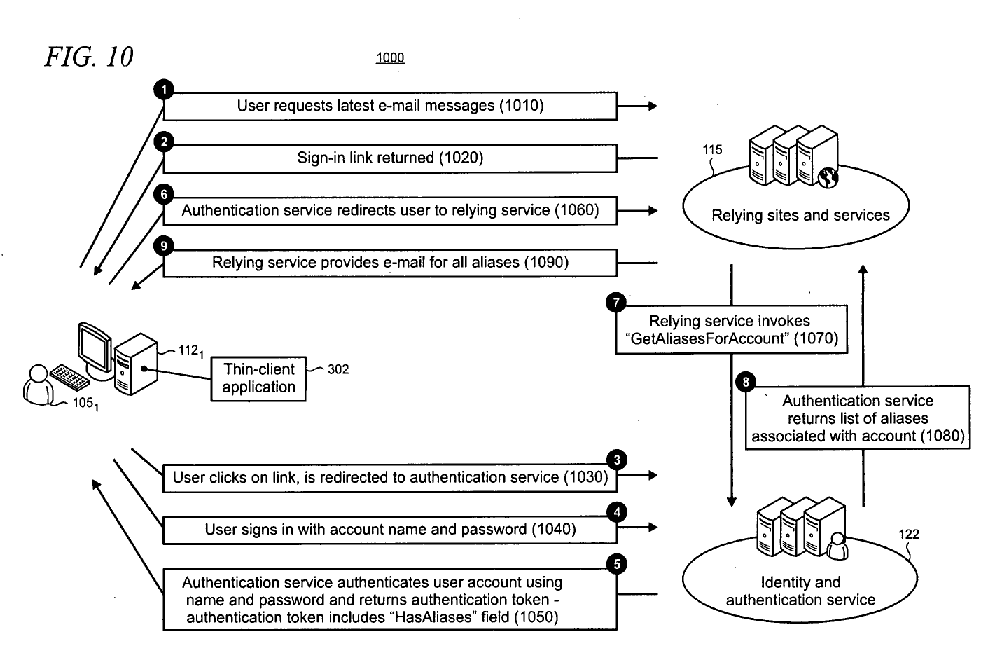

FIG. 10 shows a third illustrative usage scenario 1000 in which a user may receive e-mail messages that are sent to multiple different e-mail aliases. In this example, a user 105₁ at desktop client 112₁ uses thin client application 302 to interact with a relying service 115 which comprises, in this scenario, a hosted e-mail service. The user 105₁ requests access to a feature of the relying service 115 that enables e-mail messages addressed to multiple different aliases to be collectively retrieved (1010).

The relying service 115 will return a page containing a sign-in link (1020). When the user 105₁ clicks on the link, the user is redirected to the identity and authentication service 122 (1030) to perform authentication of the user 105₁ on behalf of the relying service 115. The identity and authentication service 122 presents a sign-in dialog box with which the user 105₁ signs in with an alias and password (1040).

The identity and authentication service 122 authenticates the user 105₁ using the alias and password supplied and returns an authentication token back to the client (1050). The authentication token will contain data, in encrypted form, including the main account name, password, and the AUID associated with the alias. In addition, the authentication token will contain a HasAliases field. (It is noted that for thick-client applications 306, the HasAliases field is also populated into the HTTP header of the response from the identity and authentication service 122). The HasAliases field includes a timestamp to indicate the last change to the alias (e.g., the time it was created, renamed, had its attributes updated, etc.).

The identity and authentication service 122 redirects the user 105₁ to the relying service 115 (1060). The relying service 115 can pull the data from the authentication token passed from the client including the main account name. When the relying service 115 reads the HasAliases field from the authentication token, it can invoke the GetAliasesForAccount method that is exposed through the aliases API 704 (FIG. 7) (1070).

The identity and authentication service 122 returns a list of aliases that the user 105₁ has associated with the main account name in response to the API call from the relying service (1080). The relying service 115 can then provide the all of the e-mail addressed to the various e-mail aliases to the user 105₁ (1090). The e-mail aliases may be cached by the relying service 115 until the timestamp in the HasAliases field indicates that an alias has been changed. At that point, the relying service 115 can make another GetAliasesForAccount call to get the updated list of aliases.

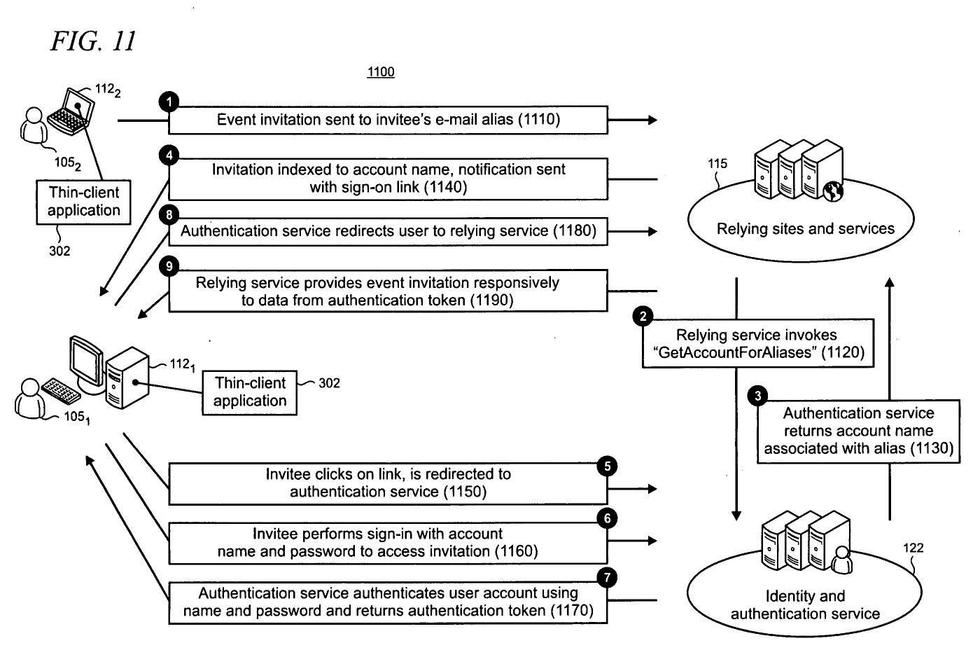

FIG. 11 shows a fourth illustrative usage scenario 1100 in which a user may be reached by others through an alias. A user 105₂ at a laptop client device 112₂ running a thin-client application 302 interacts with a relying service 115 which comprises, in this scenario, an event planning service. The user 105₂ wishes to send an invitation to an event to another user 105₁ (accordingly, and for purposes of clarity in the description that follows the user 105₂ will be referred to as the “host” and the user 105₁ will be referred to as the “invitee”).

The scenario begins when the host interacts with the relying service 115 to create an invitation that is addressed to an e-mail alias of the invitee (1110). The relying service 115 invokes the GetAccountForAliases method that is exposed through the aliases API 704 (1120) and passes the e-mail alias named in the invitation as a parameter for the method. The identity and authentication service 122 returns the main account name that is associated with the invitee's e-mail alias (1130). However, if the IsPrivate attribute for the e-mail alias is set (which indicates that the invitee 105₁ does not wish to expose the underlying account name to a look up from an alias), then the identity and authentication service 122 will not return the main account name in response to the API call.

Assuming the alias is not set to private, the relying service 115 will index the invitation to the main account name returned from the GetAccountForAliases call. A notification is made, for example by e-mail, so that the invitee can sign in to get the invitation (1140). The invitee may click on a link in the notification to be redirected to the identity and authentication service 122 (1150) and signs in using either the user's main account name and password or an alias and password (1160).

The identity and authentication service 122 authenticates the invitee using the credentials supplied and returns an authentication token back to the client (1170). The authentication token will contain data including the main account name, password, and the AUID associated with the alias. The identity and authentication service 122 then redirects the user invitee to the relying service 115 (1180). The relying service 115 can then provide the event invitation responsively to the data from the authentication token (1190).

In the scenario above, the event invitation is sent to the invitee's e-mail address. In an alternative scenario, if the event invitation is sent to an e-mail address that is not an alias, then the notification can provide the invitee with an option to add the e-mail address as a verified e-mail alias when signing in to the service using the main account name and password.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for identifying a user to a service through utilization of one or more aliases, the method comprising the steps of:
utilizing an alias data model by which the one or more aliases are maintained as unique sub-identities of a main account;
exposing methods for manipulating the one or more aliases; and
authenticating the user to the main account when the user signs in to the service using one of the one or more aliases.

2. The method of claim 1 in which the exposed methods include at least one of creating an alias, deleting an alias, or renaming an alias.

3. The method of claim 1 including a further step of associating one or more attributes with an alias.

4. The method of claim 3 in which the exposed methods include updating attributes associated with the alias.

5. The method of claim 3 in which the attributes associated with the alias provide at least one of a) identifying whether the alias is verified, b) identifying whether the alias is private, c) identifying a type of alias, or d) providing context for the alias.

6. The method of claim 1 in which the alias data model enables the one or more aliases to be selected from ones of e-mail addresses, nicknames, gamertags, or mobile phone numbers.

7. The method of claim 1 in which the alias data model provides for an immutable identifier to be associated with each of the one more aliases.

8. A computer-readable medium including instructions which, when executed by one or more processors disposed in an electronic device, perform a method for operating an API, the method comprising the steps of:
configuring the API to expose methods for manipulating an alias associated with a main account to a caller, the alias being arranged under an alias data model as a sub-identity of the main account;
receiving a call at the API requesting a list of aliases that are associated with the main account; and
returning the list of aliases responsively to the call.

9. The computer-readable medium of claim 8 in which the caller is a relying service, the relying service being arranged for relying upon the API methods for a) authenticating a user of the relying service using an alias, b) receiving a list of aliases associated with the main account, or c) receiving an identification of the main account that is associated with an alias.

10. The computer-readable medium of claim 8 in which the data model further provides that the alias is unique and identified using an immutable identifier.

11. The computer-readable medium of claim 8 in which the data model further provides that the alias has one or more associated attributes that provide at least one of a) identifying whether the alias is verified, b) identifying whether the alias is private, c) identifying a type of alias, or d) providing context for the alias.

12. The computer-readable medium of claim 11 in which the method further includes steps of receiving a call at the API requesting the main account that is associated with an alias and, if the one or more attributes do not indicate that the alias is private, returning an identification of the main account to the caller.

13. The computer-readable medium of claim 11 in which the method further includes a step that comprises at least one of a) creating an alias in response to a call to the API to create the alias, b) deleting an alias in response to a call to the API to delete the alias, c) renaming an alias in response to a call at the API to rename the alias, or d) changing the attributes that are associated with an alias.

14. The computer-readable medium of claim 13 in which the alias is created as a verified alias if a verification token is provided when the alias is created.

15. A method for authenticating a user to a service using an alias, the method comprising the steps of:
receiving an alias and password from a user when signing in to the service, the alias and password being associated with a main account for the user that is maintained by the service;
authenticating the user using the received alias and password; and
sending an authentication object to the service, the authentication object having associated data, the data identifying the main account and a unique identifier associated with the alias so that the service may display protected content or provide a service that is personalized to the user responsively to the authentication object.

16. The method of claim 15 in which the object comprises either an authentication token or an authentication ticket.

17. The method of claim 15 in which the authentication object further includes data a) that indicates that the main account has one or more associated aliases and b) includes a timestamp that indicates a time at which an alias was last changed.

18. The method of claim 17 including a further step of exposing the one or more aliases associated with the main account in response to a call from the service.

19. The method of claim 18 in which the one or more aliases are exposed through an API.

20. The method of claim 15 in which the service is selected from one of e-mail service, instant messaging service, file sharing service, content sharing service, weblog service, event planning service, web service, social networking service, personal web page service, or web-based forum, group, or discussion service.
